(19) United States
(12) Patent Application Publication
(10) Pub. No.: US 2026/0094736 A1
(43) Pub. Date: Apr. 2, 2026

(54) A MESON CONVERTER FOR GENERATING THERMAL ENERGY FROM A MESON FLUX

(71) Applicant: LazeraH AB, Göteborg (SE)

(72) Inventors: Leif HOLMLID, Mölnlycke (SE); Dan GALL, Göteborg (SE)

(21) Appl. No.: 19/110,672

(22) PCT Filed: Aug. 18, 2023
(86) PCT No.: PCT/SE2023/050835

§ 371 Date: Mar. 11, 2025

(30) Foreign Application Priority Data
Sep. 12, 2022 (SE) 2251051-5

(51) Int. Cl. G21H 3/00

(52) U.S. Cl. CPC G21H 3/00

(57) ABSTRACT

A meson converter, and method, for generating thermal energy from a meson flux includes a plurality of absorber layers, where each absorber layer includes a metal plate of a first type, and a plurality of heat transport layers where each heat transport layer includes a metal plate of a second type, where the plurality of absorber layers and the plurality of heat transport layers are arranged alternately in a stack, where each absorber layer is arranged in contact with at least one heat transport layer, where any two adjacent layers in the stack have dissimilar densities and where the thermal conductivity of the metal plate of the second type is higher than the thermal conductivity of the metal plate of the first type.

### FIELD OF DISCLOSURE

The present disclosure relates to the field of energy converters.

### BACKGROUND

Nuclear processes, such as fusion, are by many predicted to play a central role in the energy generation of the future. One of the challenges of extracting energy from nuclear processes is to utilize the large amount of energy that exists in the form of particle radiation originating from the nuclear reaction.

One group of particles that may be generated from nuclear processes comprise light mesons such as kaons and pions. A problem with these mesons is that one needs to extract energy from them before the decay into muons and neutrinos, which are notoriously hard to utilize. Another problem is to extract the energy from long-lived neutral kaons which pass with no interaction through most materials. At present, the detection of light mesons are sometimes tackled by using large calorimeters, i.e. tanks with various expensive fluids. Albeit being suitable for collecting light mesons in large systems, large calorimeters are impractical for energy extraction at a small or medium scale in power generators.

It is an aim of the present disclosure to provide a meson converter for generating thermal energy from a meson flux that can be used in in a wide range of power generation environments.

### SUMMARY OF THE DISCLOSURE

A first aspect of the present disclosure provides a meson converter for generating thermal energy from a meson flux, the meson converter comprising, a plurality of absorber layers, and a plurality of heat transport layers, where the plurality of absorber layers and the plurality of heat transport layers are arranged alternately in a stack, where each absorber layer is arranged in contact with at least one heat transport layer, and where any two adjacent layers in the stack have dissimilar densities.

According to an embodiment of the present disclosure each absorber layer have a first density, and each transport layer have a second density being different from the first density.

According to another embodiment of the present disclosure each absorber layer comprises a metal plate of a first type.

According to yet another embodiment of the present disclosure the metal plate of the first type comprises at least 50 wt. % of an element with an atomic number of at least 26.

According to yet another embodiment of the present disclosure the metal plate of the first type comprises at least 50 wt. % lead, preferably at least 99 wt. % lead.

According to yet another embodiment of the present disclosure each heat transport layer comprises a metal plate of a second type with a thermal conductivity that is higher than the thermal conductivity of any one of the absorber layers.

According to yet another embodiment of the present disclosure the metal plate of the second type has a thermal conductivity of at least 200 W/m·K.

According to yet another embodiment of the present disclosure the metal plate of the second type comprises aluminium, gold, copper or silver.

According to yet another embodiment of the present disclosure each heat transport layer comprises a conduit configured to conduct a cooling fluid, preferably water.

According to yet another embodiment of the present disclosure the thickness of the stack is at least 2.7 cm, preferably at least 10.8 cm.

According to yet another embodiment of the present disclosure the meson converter further comprises a chamber for containing and conducting water, where the chamber is connected to one side of the stack.

According to yet another embodiment of the present disclosure the meson converter is planar or curved.

A second aspect of the present disclosure provides use of a meson converter for generating thermal energy from a meson flux.

According to an embodiment of the present disclosure the meson flux comprises a kaon flux.

### BRIEF DESCRIPTION OF THE DRAWINGS

FIG. 1 is a schematic illustration of a meson converter comprising a plurality of absorber layers, and a plurality of heat transport layers,

FIG. 2 is a schematic illustration of a meson converter where the absorber layers each comprise a metal plate of a first type and where the heat transport layers each comprise a metal plate of a second type,

FIG. 3 is a schematic illustration of a meson converter where each heat transport layer comprises a conduit configured to conduct a cooling fluid, preferably water,

FIG. 4 is a schematic illustration of a meson converter where each heat transport layer comprises a conduit configured to conduct a cooling fluid, preferably water and where each conduit is connected to a main conduit,

FIG. 5 is a schematic illustration of a meson converter where each heat transport layer is connected to a heat conductor and where the meson converter comprises a chamber configured to conduct cooling water in order to cool the heat conductor,

FIG. 6 is a schematic illustration of a meson converter comprising a plurality of absorber layers, and a plurality of heat transport layers, where the meson converter is curved.

### DETAILED DESCRIPTION OF THE DISCLOSURE

In the following, general embodiments as well as particular exemplary embodiments of the disclosure will be described. References will be made to the accompanying drawings. It shall be noted, however, that the drawings are exemplary embodiments only, and that other features and embodiments may well be within the scope of the disclosure as claimed. Further, the mentioning of references such as “a” or “an” etc. should not be construed as excluding a plurality, and the term “disclosure” may herein be used interchangeably with the term “invention”.

Unless otherwise defined, all terms of art, notations and other scientific terms or terminology used herein are intended to have the meanings commonly understood by those of skill in the art to which this disclosure pertains. Certain terms of art, notations, and other scientific terms or terminology may, however, be defined specifically as indicated below.

The present disclosure provides a meson converter for generating thermal energy from a meson flux, and the use of a meson converter for generating thermal energy from a meson flux. The meson converter may combine regeneration of long-lived neutral kaons, with efficient energy absorption and energy extraction.

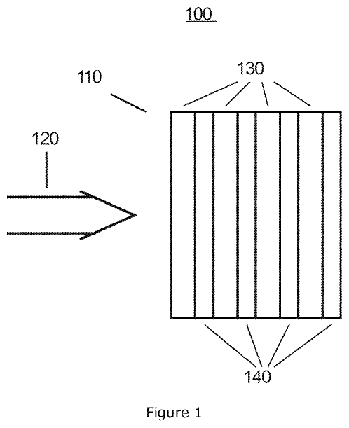

FIG. 1 schematically illustrates a meson converter 100 according to an embodiment of the present disclosure, where the meson converter 100 comprises plurality of absorber layers 130 and a plurality of heat transport layers 140. The plurality of absorber layers 130 and the plurality of heat transport layers 140 are here arranged alternatively in a stack 110, with each absorber layer 130 being arranged in contact with at least one heat transport layer 140. In operation, the meson converter 100 may be aligned such that a flux 120 of incoming mesons is incident on the meson collector 100 on top of the stack 110. In other words the meson converter 100 may be aligned such that the meson flux 120 direction is aligned in parallel, or at least partly in parallel, with the normal vectors of the absorber layers 130.

According to the present disclosure, any two adjacent layers in the stack of the meson convertor have dissimilar densities. It has been found that the stacking of such layers with dissimilar densities may induce neutral particle oscillations in a flux of mesons, such as kaons. The stacking of said layers with dissimilar densities may consequently cause regeneration of long-lived neutral kaons, K-long, into short-lived neutral kaons, K-short. K-short decay in 90 picoseconds with 69% probability to pairs of charged pions, and with 31% probability into pairs of neutral pions which then decay to high-energy gamma photons. K-short is thus significantly easier to extract energy from than K-long, which with its relatively long decay time of 52 ns usually pass through most materials with no interaction. When referring to density herein, it will be appreciated that it is referred to density by weight.

Each absorber layer may according to a particular embodiment of the disclosure have a first density, and each transport layer may have a second density being different from the first density. Periodic density fluctuations in the stack has been found to be particularly preferable in order to induce neutral particle oscillations in a flux of mesons, such as kaons.

The absorber layers may according to the present disclosure be configured to absorb radiation, such as radiation in the form of charged particles and/or in the form of electromagnetic radiation. Electromagnetic radiation may here typically comprise radiation in the form of x-rays and gamma rays, and may for example originate as a decay product or as bremsstrahlung. Charged particles may generally be absorbed in the absorber layers as they lose energy by ionization of the material of the absorber layer, or by radiation of bremsstrahlung during the braking in the material of the absorber layer. Electromagnetic radiation, such as x-rays and/or gamma rays, may on the other hand be absorbed by well-known mechanisms such as photoelectric absorption, Compton scattering or pair formation.

The absorber layers in the meson converter may thus generally absorb at least part of the incoming mesons by absorbing charged pions and kaons, and additionally by absorbing the gamma rays originating from neutral pions. Energy from charged pions and kaons may thus be transferred to the absorber for example though absorbance of the bremsstrahlung, while gamma rays from the decay of neutral pions may be absorbed though known mechanisms such as photoelectric absorption, Compton scattering or pair formation.

According to an embodiment of the present disclosure, each absorber layer 130 may comprise a metal plate of a first type 150. Metal plates have been found to be preferable to for example ceramic materials, as metal plates provide adequate absorption properties in combination with good thermal conductivity and thermal expansion properties. As high temperatures may be reached in the meson converter 100 under influence of a high meson flux 120, it is preferable that each absorber layer 130 does not crack, or otherwise break, due to thermal strain. Metal plates may further contribute to transport heat, thus preventing overheating of the absorber layer 130. FIG. 2 schematically illustrates an embodiment of the present disclosure where each absorber layer 130 comprises a metal plate of a first type 150. The plurality of absorber 130 layers in the form of metal plates of a first type 150 and the plurality of heat transport layers 140 are here arranged in a stack 110. A metal plate of a first type 150 may generally herein alternatively be termed a metal plate absorber.

In order to efficiently absorb charged particles and gamma rays, it is preferable that the absorber layers comprise a material with a high atomic number. The latter results in an increased electromagnetic stopping power, and an increased interaction with photons. Metal plates consisting of iron, or at least comprising at least 50 wt. % iron, have been found to be suitable for use as a metal plate of the first type according to the present disclosure. Heavier metals may alternatively constitute the metal plate of the first type, optionally as an alloy. According to a particular embodiment the present disclosure the metal plate of the first type comprises at least 50 wt. % of an element with an atomic number of at least 26.

In a particular embodiment of the present disclosure, the metal plate of the first type comprises at least 50 wt. % lead. Lead may in certain cases be preferred, due to its high atomic number and density. The metal plate of the first type may for example comprise at least 90 wt. % lead, or even at least 99 wt. % lead. Due to the toxic nature of lead, any metal plate of the first type that comprises lead, may according to the present disclosure be coated with a non-toxic material, e.g. a light metal such as aluminium or titanium.

The dimensions of the meson converter may generally vary, but is preferably determined in order to optimize induction of neutral particle oscillations in a flux of mesons, such as kaons. The dimensions of the meson converter may in other words be chosen in order to maximize regeneration of K-long into K-short. As K-short may form at the edge of the meson converter, the thickness of the meson converter, i.e. the thickness/height of the stack, may be chosen to be at least equal to the expected propagation length for K-short. As K-short has an expected half-life of 90 picoseconds and traveling at speeds approaching, but limited by the speed of light, the expected propagation distance for a K-short is then at most approximately 2.7 cm. The thickness of the stack of the meson converter may thus according to the present disclosure be at least 2.7 cm. As the K-shorts continue to decay as they propagate through space, a K-short generated at the entry into the meson converted will with 95% probability have decayed by the time it has travelled at most approximately 11 cm into the meson converter. The exact thickness of the meson converter will be dependent on the exact rate of regeneration, but it has been found that a thickness of the meson converter of approximately 4 times the decay propagation distance, i. e 10.8 cm, is preferable. In a particular embodiment of the present disclosure, the thickness of the meson converter is between 10 cm and 100 cm, more preferably between 10 cm and 50 cm.

The thickness of each absorber layer and each heat transport layer may generally be dependent on the total thickness of the stack. The absorber layers may generally be in the range 1-10 mm, preferably in the range 2-7 mm. The heat transport layers may generally be in the range 1-10 mm, preferably in the range 2-7 mm. In a particular embodiment the thickness of each absorber layer and the thickness of each heat transport layer is 5 mm.

The meson converter comprises according to the present disclosure a plurality of heat transport layers, where each absorber layer is arranged in contact with at least one heat transport layer. The employment of such heat transport layers is preferred in order to prevent the absorber layers from overheating and to keep a uniform temperature in the meson converter. The latter contributes to mitigate thermal strain, and to maintain a more uniform thermal conductivity across the meson converter. Each absorber layer is according to the present disclosure arranged in contact with at least one heat transport layer, but it will be appreciated by a person skilled in the art that each absorber layer may be in contact with two heat transport layers, one on each side. The contact between each absorber layer and one or two heat transport layers is preferable in that each absorption layers may then maintain a desired temperature during operation of the meson converter.

The thermal conductivity of each heat transport layer is preferably higher than the thermal conductivity of any one of the absorber layers. Such a configuration allows the meson converted to be specifically designed with absorber layers specifically adapted to absorbing radiation, and with heat transport layers specifically adapted to transport heat away from the absorber layers. An absorber layer may for example comprise a metal plate of a first type which is particularly suitable for absorbing radiation, but which is not particularly conductive, e.g. iron and lead. In order to effectively transport heat away from the absorber layer, a heat transport layer comprising a metal plate of a second type may be employed. The metal plate of the second type may have higher thermal conductivity than the metal plate of the first type. The metal plate of the second type may for example comprise aluminium. In a particular embodiment of the present disclosure, the metal plate of the second type has a thermal conductivity of at least 200 W/m·K. A metal plate of the second type having said thermal conductivity has been found to be particularly suitable for obtaining effective heat transport in the meson converter. Examples of materials that may be used in the metal plate of the second type include aluminium, gold, copper or silver. The metal plate of the second type may thus comprise aluminium, gold, copper or silver, for example at a quantity of at least 50 wt. %, or more preferable at a quantity of at least 95 wt. %. The thermal conductivity of any one heat transport layer is in a particular embodiment higher than the thermal conductivity of any one of its adjacent absorber layers, at least any one of its adjacent absorber layers being in contact with the heat transport layer.

FIG. 2 schematically illustrates a meson converter 100 according to the present disclosure where each heat transport layer 140 comprises a metal plate of a second type 160. The absorption layers 130 are here illustrated, optionally as a metal plate of a first type 150, where each absorber layers is in direct contact with two heat transport layers 140 in the form of metals plates of the second type 160, one on each side. The plurality of absorber layers 130, optionally in the form of metal plates of a first type 150, and the plurality of metal plates of the second type 160 are here arranged in a stack 110. A metal plate of a second type 160 may generally herein alternatively be termed a metal heat transport plate.

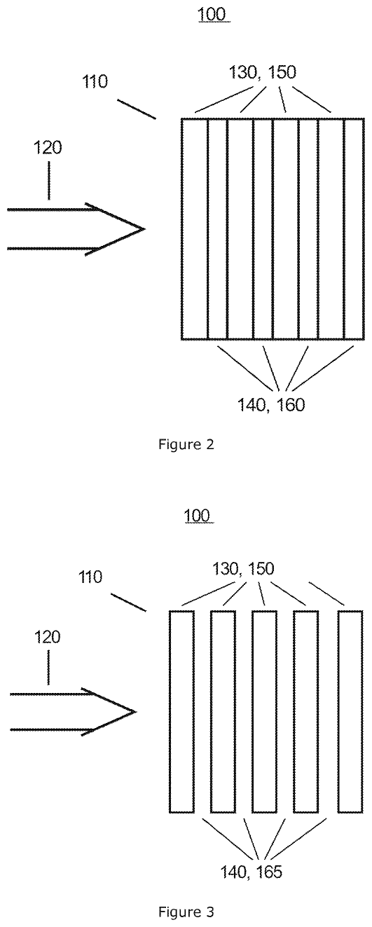

FIG. 3 schematically illustrates a meson converter 100 according to an embodiment of the disclosure where each heat transport layer 140 comprises a conduit 165 configured to conduct a cooling fluid, preferably water. Said conduit 165 may thus be employed as a conduit 165 for a flow of cooling fluid which may actively cool the absorption layers 130. Despite most fluids, including water, having a relatively low intrinsic thermal conductivity, effective thermal control of the absorption layers 130 may be obtained by controlling the flow and temperature of the cooling fluid. The cooling fluid may further be utilized, directly or indirectly for the purpose of generating electrical power. The cooling fluid may for example be used in order to generate steam, which further may be used in order to drive an electrical turbine, not shown. Each conduit 165, may for example be a void between each absorber layer. The conduits 165 may as schematically illustrated in FIG. 4 be connected to a fluid source, such as a main conduit 166, so that the cooling fluid may be circulated though the meson converter 100. The meson converter 100 may further generally comprise a frame 210, or any similar support structure configured to support the various components of the meson converter 100.

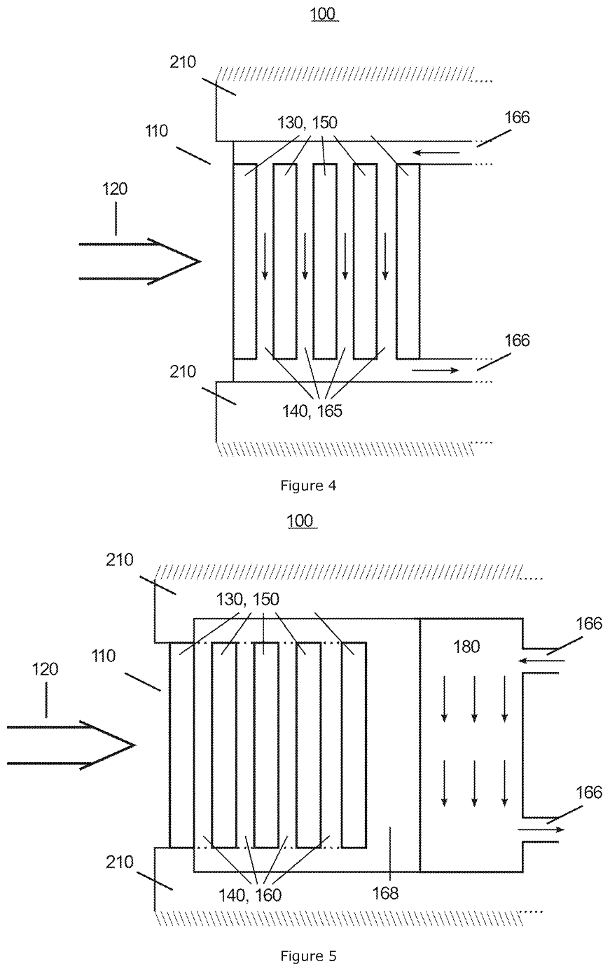

It will be appreciated by a person skilled in the art that a general cooling system may be combined with other embodiments of the present disclosure, for example the embodiment where each heat transport layer 140 comprises a metal plate of a second type 160. In the latter embodiment a cooling fluid system may be employed in order to cool each heat transport layer 140, for example in a particular separate part of the meson converter 100. FIG. 5 schematically illustrates a particular embodiment of the present disclosure where the meson converter 100 further comprises a chamber 180 for containing and conducting water. The chamber 180 may be connected to one side of the stack 110, and may for example be connected directly or indirectly to the heat transport layers 140. The chamber 180 may for example be connected to the heat transport layers 140 via one or more heat conductors 168, such as metallic conductors, or the heat transport layers may as an alternative extend into the chamber 180. The one or more heat conductors 168 may for example be in contact with the chamber 180 in order to enable cooling water flowing through said chamber 180 to cool the one or more heat conductors 168.

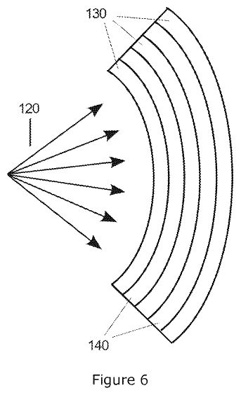

A meson converter 100 may generally be employed in order to absorb energy from nuclear reactions, such as fusion reaction at a small or medium scale. As many nuclear reactions typically are occurring in a limited spatial volume, the meson flux 120 that is generated in such processes may propagate with a semi-spherical distribution from their source of origin. A meson converter 100 employed in order to convert and absorb mesons from a nuclear reaction may therefore be designed to curve around said source of origin for a meson flux. The meson converter 100 may thus, as schematically illustrated in FIG. 6 be curved. The absorber layers 130 and the heat transport layers 140 of the meson converter may thus consequently be curved. Alternatively the meson converter 100 may be planar, for example such that several meson converters may be assembled into a suitable shape. It will be appreciated by a person skilled in the art that the various shapes of the meson converted herein described, e.g. the embodiment where the meson converter 100 is curved, may be combined with any embodiment of the present disclosure.

The meson converter 100 may generally comprise additional parts such as a frame 210, fastening means for mounting any absorption layers 130 and or heat transport layers 140, water cooling equipment, such as valves, conduits, flanges etc. The actual assembly of a meson converter 100 according to the description herein may, as will be appreciated by a person skilled in the art, be performed in a variety of ways. Absorption layers 130 in the form of metal plates of a first type 150 may for example be mounted in an external frame 210 that is attached to the metal plates of the first type 150 along the planar edge of the metal plates of the first type 150. Heat transport layers 140 in the form of metal plates of a second type 160 may for example be mounted in the external frame that is attached to the metal plates of the second type 160 along the planar edge of the metal plates of the second type 160. Metal plates of a first type 150 and metal plates of a second type 160 may further be brought in contact with each other using a wide variety of techniques. The metal plates may for example be bonded together using high temperature bonding where the metals plates are heated to a temperature where one type of plate softens and conforms to its adjacent plates. FIGS. 4 and 5 schematically illustrate a meson converter 100 comprising a frame 210.

A second aspect of the present disclosure provides use of a meson converter for generating thermal energy from a meson flux. The meson flux may comprise a kaon flux.

1. A meson converter for generating thermal energy from a meson flux, the meson converter comprising:
a plurality of absorber layers, each of the absorber layers comprising a metal plate of a first type; and
a plurality of heat transport layers, each of the heat transport layers comprising a metal plate of a second type,
wherein the plurality of absorber layers and the plurality of heat transport layers are disposed alternately in a stack, each of the absorber layers being disposed in contact with at least one of the heat transport layers, any two adjacent layers of the plurality of absorber layers and the plurality of heat transport layers in the stack have dissimilar densities, a thermal conductivity of the metal plate of the second type being higher than a thermal conductivity of the metal plate of the first type.

2. The meson converter according to claim 1, wherein each of the absorber layers has a first density, and each of the transport layers has a second density that is different from the first density.

3. The meson converter according to claim 1, wherein the metal plate of the first type comprises at least 50 wt. % of an element with an atomic number of at least 26.

4. The meson converter according to claim 1, wherein the metal plate of the first type comprises at least 50 wt. % lead.

5. The meson converter according to claim 1, where the metal plate of the second type has a thermal conductivity of at least 200 W/m·K.

6. The meson converter according to claim 1, where the metal plate of the second type comprises one of aluminum, gold, copper, and silver.

7. The meson converter according to claim 1, wherein each of the heat transport layers comprises a conduit configured to conduct a cooling fluid.

8. The meson converter according to claim 1, wherein a thickness of the stack is at least 2.7 cm.

9. The meson converter according to claim 1 further comprising a chamber configured to contain and conduct water, the chamber being connected to one side of the stack.

10. The meson converter according to claim 1, wherein the meson converter is planar.

11. A method comprising:
generating, by the meson converter according to claim 1, thermal energy from the meson flux.

12. The method according to claim 11, wherein the meson flux comprises a kaon flux.

13. The meson converter according to claim 4, wherein the metal plate of the first type comprises at least 99 wt. % lead.

14. The meson converter according to claim 7, wherein the cooling fluid is water.

15. The meson converter according to claim 8, wherein the thickness of the stack is at least 10.8 cm.

16. The meson converter according to claim 1, wherein the meson converter is curved.
